(19) United States
(12) Patent Application Publication
(10) Pub. No.: US 2006/0277072 A1
(43) Pub. Date: Dec. 7, 2006

(54) System for creating a medical chart

(76) Inventors: Cindy Bell, Woodridge, IL (US); Kim Sell, Wonder Lake, IL (US); Randy Paul, Brea, CA (US); Octavio Medrano, Crystal Lake, IL (US)

Correspondence Address: Pauley Petersen & Erickson, Suite 365, 2800 West Higgins Road, Hoffman Estates, IL, 60195, US

(21) Appl. No.: 11/145,805

(22) Filed: Jun. 6, 2005

(51) Int. Cl. G06F 19/00

(52) U.S. Cl. 705/3

(57) ABSTRACT

A system of creating and maintaining medical records provides a central monitoring system for a patient-care facility. The system can include a real-time medical charting interface for consistent and objective patient data entry and logging the time identification of patient data entry. The interface can display real-time objective data and can include a first menu of first charting categories; a second menu populated with keywords based upon the charting category selected from the first menu; and a third menu populated with values for the keyword selected from the second menu. The menus can be concurrently presented for data entry allowing efficient charting of the patient's condition. Patient data can be digitized to be distributed on a network.

### BACKGROUND OF THE INVENTION

Manual data capture in the medical field has, in the past, been known to suffer shortcomings. Thus, computer-based patient record data collection systems have been proposed to solve certain of the manual data capture shortcomings. Yet the ease of use of such systems and their limited utility is often cited as the major stumbling block to computer-based patient record adoption. Current computer-based patient record systems can be too complicated, too restrictive, or too slow to be used effectively by many caregivers. Some computer-based patient record systems may require that the time-constrained caregivers learn separate operating methods or may require training on the computer systems to obtain adequate results from the system. Further, not all necessary patient information may be available through a single interface.

Known computer-based patient record systems fall into several categories including those that focus on capturing structured data through the use of pick lists, those that rely on text generated by dictation and/or automated speech recognition, and those that attempt to combine both methods. There can be limitations for each known system. Some known systems use a point-and-click input method for data entry into structured data computer forms. Some systems allow for dictation of free text and subsequent transcription. Many systems require extensive training of the caregivers, the computer system, or both. Thus, known systems for the capture of the necessary data can be cumbersome and can slow office production.

Thus, there remains a need for a computer-based patient record system which requires little to no training on the part of the caregivers and is fast, accurate, and conveniently usable, and which provides all necessary patient data to the user. A system for generating medical charts should desirably be fast enough to be real time or near real time (hereinafter simply referred to as “real time”) in order to allow for review of the data intake and possible decision support during the time the patient is in need, especially in such fields as perinatal care. Further, the system should desirably effectively utilize the captured data to reduce costs within, and provide information about, the medical care delivery system. Time spent by healthcare personnel generating, analyzing, and retrieving a patient's records should desirably be reduced. Errors in record generation and data retrieval should desirably be reduced.

### SUMMARY OF THE INVENTION

The present invention provides solutions to the above discussed shortcomings in the known art. The present invention recognizes that, within a discipline, the vocabulary may be limited and segmented into indentifiable and objective groupings. Thus, the present invention may utilize such limitations and segmentations of vocabularies to provide objective, consistent, quick, and efficient charting. The present invention can further provide data entry uniformity leading to better medical practice through the enforcement of objective criteria in the data gathering process.

In one aspect of the present invention the data capture is effectively addressed by allowing the caregivers to follow a set of categories, keywords and values expressed as details in drop down menus which are automatically called up and populated by the preceding choice of the caregiver who is doing the charting. The present invention can reduce or eliminate training by creating a menu driven system for accurately and quickly standardizing and recording care-giving routines including diagnostic data gathering. Desirably, the system can be used throughout the care-giving process to maintain consistency and objectivity. Data capture for a medical chart can be addressed through a combination of electronic monitoring equipment and caregiver observations recorded in a patient chart. Each mode of data can be captured digitally and combined in manners efficacious to the treatment of the patient. Desirably the system can provide detailed records of the care-giving process, including time of patient monitoring and care and the identification of the caregiver.

Medical chart generation for a particular area of care, e.g., perinatal care, generally follows a set pattern. For example, there can be a fairly standard list of categories for caregiver activity. Each activity category will have a characteristic vocabulary defined by keywords. Within the context of each keyword a variety of defined values will exist which must be charted. For example, the context of perinatal assessment will have a characteristic diagnostic category such as Uterine Contractions (UC) Evaluation. Selection of the UC diagnostic category on a first menu of an I/O charting interface by a user, i.e., caregiver, at a workstation will call up a second menu of a characteristic list of details, or symptom keywords, dealing specifically with UC assessment, e.g., contraction intensity. Selection of the contraction intensity symptom keyword will call up a third menu of a characteristic list of value categorizations, be it types, ranges, or the like, e.g., in the case of contractions, from absent through strong. Selection and charting may thus be done very efficiently on an I/O device with light pen, touch pad, mouse or the like. Desirably each of the category, keyword, and value entry menus remain accessible on one screen of the I/O interface for providing the caregiver easy accessibility and awareness of the charting functions.

In some embodiments the category selection may pertain to the entire care-giving process including admitting and discharge of the patient. Desirably, each section of the charting function may be arranged for ease of use, such as by frequency of occurrence or use of the category or keyword or value. The charting functions may further be arranged to accommodate, and be updated to account for, changes in legal and/or medical standards. Intelligent selection and arrangement of the category, keyword, and value menus can provide broad charting functionality while capturing all necessary details of the care-giving.

Once the data is captured electronically and digitized it can be distributed for availability throughout the system such as by a connection through a network switch to various servers and peripherals, including the I/O interfaces used for charting.

### BRIEF DESCRIPTION OF THE DRAWINGS

FIG. 1 is a schematic illustration of a perinatal patient monitoring system according to one embodiment of the present invention.

FIG. 2 illustrates aspects of the charting function of one embodiment of the present invention.

FIG. 3 illustrates aspects of the charting function of one embodiment of the present invention.

FIG. 4 illustrates aspects of the charting function of one embodiment of the present invention.

### DETAILED DESCRIPTION OF THE PREFERRED EMBODIMENTS

Discussion of the sections or parts of the exemplary embodiment will be given herein with respect to specific functional tasks or task groupings that are in some cases arbitrarily assigned to the specific sections for explanatory purposes. It will be appreciated by the person having ordinary skill in the art that a system according to the present invention may be arranged in a variety of ways, or that functional tasks may be grouped according to other nomenclature or architecture than is used herein without doing violence to the spirit of the present invention.

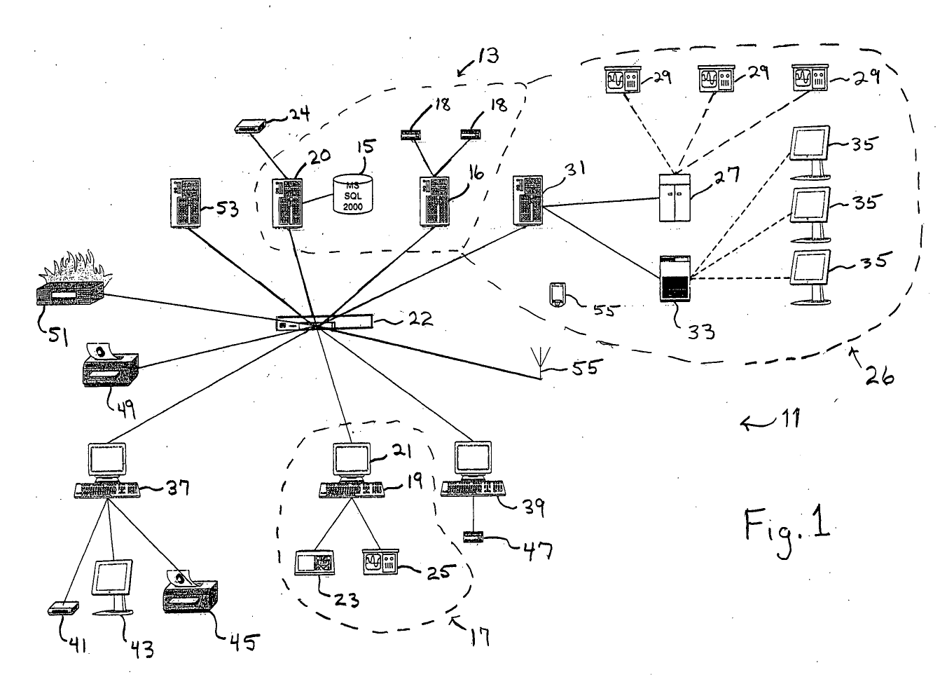

Referencing FIG. 1, a medical chart generating system 11 is shown. The system 11 is shown in the exemplary form of a perinatal patient monitoring environment although it will be realized by the person having ordinary skill in the art that other applications are readily adaptable to, and can exist within, the spirit of the present invention. In general, the system 11 can include a data management section 13 including a database 15 containing a roster of patients and further including a fixed, i.e., nondynamic, data storage device such as the optical server 16 connected to the system 11 through a network switch 22 and having redundant optical drives, collectively 18. Database management and applications may be obtained through a database/applications server 20 connected to the system 11 through the network switch 22. Peripherals for remote access to the system 11, such as a modem 24 for sending patient data and receiving remote diagnostics from offsite monitors or physicians may further be connected to the database/applications server 20.

The system 11 can further include the functionality of a bedside workstation 17 enabling the entry or selection, or both, (hereinafter simply referred to as “entry,” “entering” and forms thereof) of a patient record from the roster and having an interactive, real-time medical charting I/O interface accessed through the workstation 17 as illustrated by the component keyboard 19 and screen 21. The workstation 17 may accept direct or indirect input from various patient monitoring devices such as a non-invasive blood pressure monitor 23 or a fetal monitor 25.

The system 11 can further include the functionality of a surveillance section 26 whereby patient data may also be gathered without direct access to a workstation 17 through the use of a data acquisition unit 27 which may, e.g., be constructed and arranged to accept analog signals from a plurality of fetal monitors, collectively 29, and digitize the signals before providing them to a surveillance server 31 for further availability in the system 11 such as by the illustrated connection through the network switch 22. Alternatively, the fetal monitors may directly output data in digital form. One example of such further availability is illustrated by providing the data from fetal monitors 29 to a multiplexing video processor 33 which provides signals for display of the fetal monitor data to display screens, collectively 35, located remotely from the patient and fetal monitor 29, such as at nurses stations or doctor lounges, or the like.

Patient management functionality may further be provided by non-bedside workstations 37, 39 located remotely from the patient and located, e.g., at a nurses station and a medical records review station, respectively, and connected to the system 11 through the network switch 22. It will be noted that peripherals, such as the fax modem 41, secondary display screen 43, and printer 45 connected to the workstation 37, and the optical drive 47 connected to workstation 39, may be provided within the system 11, as necessary or desired. Likewise, a variety of peripherals for remote communications including the output or the input of data, such as a printer 49, internet firewall 51, web server 53, and wireless communications apparatuses, collectively 55, may be located throughout the system 11 and be provided with access to system resources through the network switch 22.

The database 15 may be controlled by a database management program such as a commercial SQL software package, e.g., MICROSOFT SQL 2000, and can provide the ability to manage the data through applications such as the .NETREPORTINGTOOL from ScriptLogic Corporation of Boca Raton, Fla., for notes charting. Further, once data has been transformed into any XML format it can be easily pushed and pulled into various other applications, including MICROSOFT OFFICE applications or the like. Appropriate computer hardware and software for the given system installation will be understood to be within the ordinary skill in the art.

The database/applications server 20 includes an Application Server software module for transaction processing and which is the access point for all data and communication to process, validate, approve, and log all requested transactions with the database from client workstations. A patient manager software module will provide a user interface for the management of patient data. Each entry or action of the care-giving process can be logged and/or charted with a time stamp and caregiver identification. Desirably, system access and user identification may be controlled through a secure login procedure such as a private password or the like. A communication software module within the database/applications server 20 allows all applications to communicate with the database/applications server 20. An optical server software module will manage the optical server 16, the optical disks 18, and the archived information thereon including status and repair of the optical storage disks and associated indexing. It will be understood that optical disks are merely representative of a fixed data storage medium and that the fixed data storage functionality is not limited to optical disks.

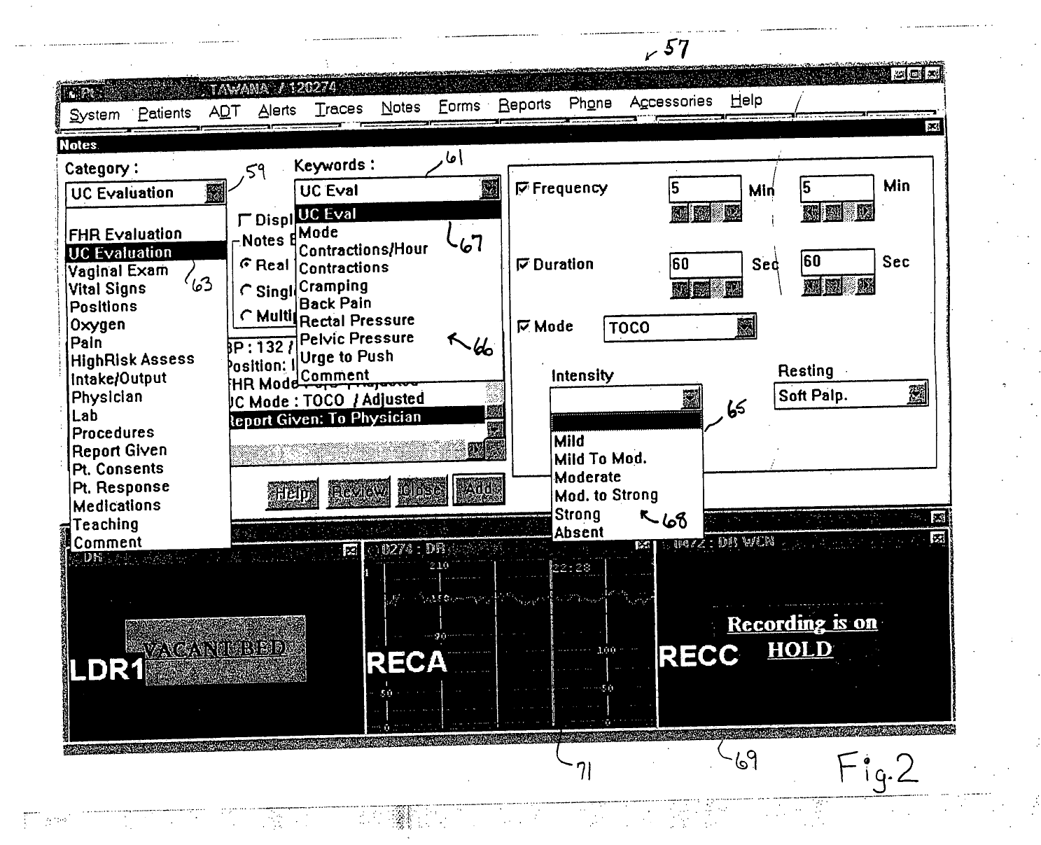

Within the appropriate computer hardware comprising the bedside workstation 17 and the patient management workstation 37 will be the appropriate communications software module, a forms software module, as further discussed below with respect to FIG. 2, a digital interface manager software module to allow the digital capture of objective fetal and maternal information, and a surveillance manager software module which allows the display of patient or fetal trace strip chart information and a patient status information display in the form of a board showing the status of multiple patients within the healthcare facility.

Within the appropriate computer hardware comprising the surveillance server 31, the surveillance manager software module will also allow the display of fetal monitor trace information in a real time format and display of the patient status board on any connected display device and will further provide audible alerts of system malfunction or patient distress if necessary. A monitor I/O software module within the surveillance server 31 will gather fetal monitor information from the data acquisition unit 27 and forward the information to database/applications server 20 for storage until the data is archived. The data acquisition unit 27 may function as an amplifier, data sampler, A/D converter, and computer interface, as necessary. A corresponding communication software module within the surveillance server 31 will allow applications to communicate back to the database/applications server 20.

Remote access to the system 11 may be obtained through the Internet by either of browser based access or application based access and may utilize virtual private networks or secure web site access. The web server 53 may likewise include the appropriate patient manager software module and communication software module for the database/applications server 20 and further include a surveillance manager software module for the display of patient or fetal trace strip chart information and status board information.

Referencing FIG. 2, an interactive, real-time medical charting I/O interface 57 for a user, i.e., caregiver, accessed through a workstation, e.g., 21 (FIG. 1), is shown. Operationally, a touch screen, mouse, light pen, or the like may be used to chart a patient's condition through use of the interactive interface 57. It will be appreciated that a workstation 21 may in some instances be substantially equivalent to all the functionalities of an I/O interface for the system 11. The interface 57 includes a selectable first menu 59 having a plurality of first details, e.g., care-giving activities or patient condition categories. A second menu 61 is provided with second details 66, i.e., keywords relevant to the first menu category, such as keywords defining the patient condition or symptoms. A third menu 65 with third details 68, i.e. values, defining or quantifying the selected second detail 67 from the second menu 61 is provided. The second menu 61 appears and is automatically populated upon selection of the first detail 63 from the first menu 59. The third menu 65 appears and is automatically populated upon selection of the second detail 63 from the second menu 61.

In FIG. 2, a diagnostic category, i.e., first detail 63, of “UC (uterine contraction) Evaluation” is selected from the first menu 59 by the caregiver. The second menu 61 then appears on the graphic interface 57 pre-populated with selectable keywords, i.e., second details 66, related to the category of “UC Evaluation” 67. In the illustrated case, the detail 67 of “UC Eval” is selected by the caregiver and the third menu 65 then appears on the graphic interface 57 pre-populated with selectable third details 68, i.e., intensity values representing a standard evaluation scale related to a UC Eval, for selection by the caregiver to complete a UC charting. Time of entry and caregiver identification for any or all parts of the charting and/or caregiver activity can be automatically date-stamped in real-time into the computerized medical chart compiled from all patient details or data gathered by the system. Further, a window 69 showing additional data, here a real-time fetal monitor strip chart trace 71, can be displayed simultaneously with the charting menus 59, 61, 65 selected by the caregiver.

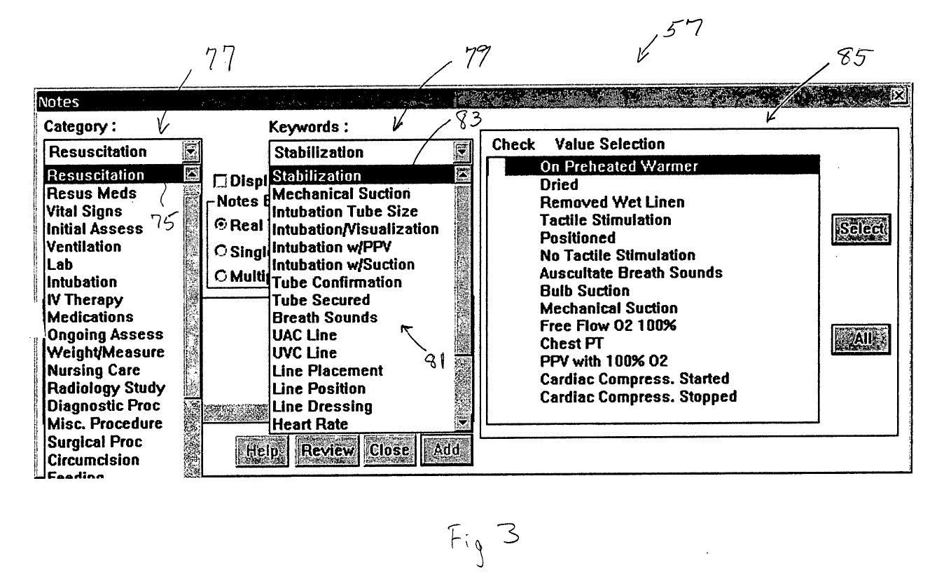

In FIG. 3, a category, i.e., first detail 75, of “Resuscitation” is selected from the first menu 77 by the caregiver. The second menu 79 then appears on the graphic interface 57 pre-populated with selectable keywords, i.e., second details 81, related to the category of Resuscitation 75. In the illustrated case, the detail 83 of “Stabilization” is selected by the caregiver and the third menu 85 then appears on the graphic interface 57 pre-populated with selectable third details 87, i.e., values representing a standard list of care-giving activities related to a Stabilization, for selection by the caregiver to complete a Resuscitation charting. Time of entry and caregiver identification for any or all parts of the charting activity can be automatically recorded in real-time into the computerized medical chart compiled from all patient details or data gathered by the system.

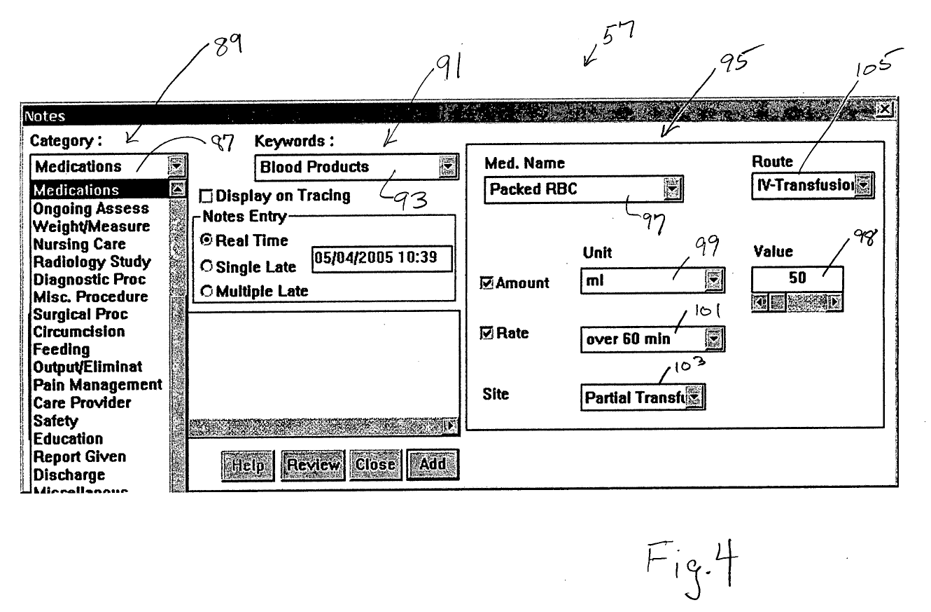

In FIG. 4, a category, i.e., first detail 87, of “Medications” is selected from the first menu 89 by the caregiver. The second menu 91, shown in an unexpanded state, then appears on the graphic interface 57 pre-populated with selectable keywords, i.e., second details, related to the category of Medications 87. In the illustrated case, the caregiver has selected the detail 93 of “Blood Products” from the second menu 91 and the third menu 95 has appeared on the graphic interface 57 pre-populated with a plurality of selectable value menus including the medication name 97, the value amount 98 and units 99 of the medication, the rate of administration 101, the site of the administration 103, and the route of the administration 105, which have been charted by the caregiver.

In each instance all selectable menus remain accessible and visible on the I/O device, or graphic interface 57 for efficient charting and switching between or among menus. The present invention thus provides a means of quickly and efficiently creating a medical chart and supplying the chart information to a variety of locations and functionalities throughout the system.

The person having ordinary skill in the art will appreciate that there has been described an exemplary embodiment. It will recognized that many of the functionalities described herein can be accomplished by a variety of computer hardware, firmware, and software; methods and apparatus within the scope of the present invention. Having thus described the present invention, it will be appreciated that many variations thereon will occur to the artisan upon an understanding of the present invention, which is therefore to be limited only by the appended claims.

We claim:

1. A method for creating a medical chart from a workstation allowing a user to chart a patient condition, the method comprising:
a) entering a first detail into the workstation from a first menu on a user interface for the workstation;
b) populating a second menu on the user interface based upon the first detail entered from the first menu;
c) entering a second detail from the second menu into the workstation;
d) populating a third menu on the user interface based upon the entered second detail from the second menu;
e) entering a third detail from the third menu into the workstation; and
f) compiling the entered details within the medical chart.

2. The method of claim 1 further comprising:
operably connecting a monitor to the patient, the monitor providing real-time objective diagnostic data; and
displaying the real-time objective diagnostic data with the entered details within the medical chart.

3. The method of claim 1 further comprising:
operably connecting a surveillance display to the workstation, the surveillance display being capable of simultaneous display of a plurality of medical charts, each medical chart corresponding with a different patient.

4. The method of claim 1 further comprising:
connecting a remote user to the medical chart thereby enabling the remote user to view information regarding the patient and enter details regarding the patient to the medical chart.

5. The method of claim 1 wherein the first detail in the first menu includes a category of caregiver activities.

6. The method of claim 5 wherein the second detail in the second menu includes a keyword related to the category of caregiver activities.

7. The method of claim 6 wherein the third detail in the third menu includes a value related to the keyword.

8. The method of claim 1 wherein each of the first detail, the second detail, and the third detail are concurrently accessible on the user interface.

9. The method of claim 1 further comprising logging in the medical chart at least one of the time or identification of the caregiver for a caregiver activity.

10. A system for generating medical charts comprising:
a) a database containing a roster of patients;
b) a workstation enabling at least one of entry and selection of a patient from the roster;
c) an interactive, real-time medical charting interface accessed through the workstation, the interface including:
d) a first menu having a plurality of first details regarding charting categories;
e) a second menu having second details regarding patient symptom keywords based upon a first detail selected from the first menu; and
f) a third menu having third details regarding values of symptoms based upon the selected second detail from the second menu.

11. The system of claim 9 wherein each of the first detail, the second detail, and the third detail are concurrently accessible on the charting interface.

12. A central monitoring system for a patient-care facility, comprising:
a) a network switch;
b) a data management section, including:
i) a fixed data storage unit server connected to the network switch and further connectable to a fixed data storage unit for management thereof,
ii) an database/applications server for the management of data flow and applications within the system, the database/applications server being connected to the network switch and further being connectable to remote communications peripherals,
iii) a database containing a roster of patients and patient charting information; the database being controlled by the database/applications server,
iv) the database/applications server having an applications server software module for the management of system transaction processing of all data and communications, a patient manager software module for controlling the user interface for management of patient data, and a communication software module for allowing system applications to communicate with the server; and
c) a workstation located proximate to a patient bedside and having
i) an I/O user interface including means for caregiver data entry/selection and patient data display,
ii) the workstation having communications, forms, digital interface manager, and surveillance manager software modules, and
iii) the workstation being connected to the network switch and the workstation further being connectable to patient monitoring devices providing patient data.

13. The central monitoring system for a patient-care facility, according to claim 12, further comprising:
a surveillance section remote from the patient beside, including:
i) a surveillance server having a surveillance manager software module for management of a display of real-time objective diagnostic data and patient status boards, and a monitor interface manager software module for the capture of analog objective diagnostic data,
ii) data acquisition hardware connectable to analog patient monitoring devices (fetal monitors) and connected to the surveillance server,
iii) the surveillance server being connected to a multiplexing video processor,
iv) the multiplexing video processor further being connectable to a plurality of video monitors, and
v) the surveillance server further being connected to the network switch.

14. The central monitoring system for a patient-care facility, according to claim 12, further comprising:
a patient management workstation remote from the patient bedside and having:
i) an I/O user interface including means for caregiver data entry/selection and patient data display, and
ii) the patient management workstation being connected to the network switch and the patient management workstation further being connectable to patient monitoring devices providing patient data and further connectable to remote communications peripherals.

15. The central monitoring system for a patient-care facility, according to claim 12, further comprising:
remote communications means including at least one of a wired and wireless communications means for accessing the system.

16. The system of claim 12 wherein the monitor interface manager software module provides for the capture of analog objective diagnostic data.

17. The system of claim 12 wherein the monitor interface manager software module provides for the capture of digital objective diagnostic data.

18. The system of claim 12 further comprising a means for logging in the medical chart at least one of the time or identification of the caregiver for a caregiver activity.

19. The system of claim 12 wherein the interface further comprises:
a first menu having a plurality of first details regarding care-giving categories;
a second menu having second details regarding care-giving keywords based upon a first detail selected from the first menu; and
a third menu having third details regarding care-giving values based upon the selected second detail from the second menu.

20. The system of claim 19 wherein each of the first detail, the second detail, and the third detail are concurrently accessible on the user interface.
